(19) United States
(12) Patent Application Publication
(10) Pub. No.: US 2024/0337705 A1
(43) Pub. Date: Oct. 10, 2024

(54) METHOD FOR MATHEMATICAL MODEL FOR ESTIMATING POLARIZATION PARAMETERS OF OIL PAPER INSULATION OF TRANSFORMER

(71) Applicant: Yunnan Power Grid Co., Ltd. Honghe Power Supply Bureau, Mengzi (CN)

(72) Inventors: Qilong ZHU, Mengzi (CN); Fu LI, Mengzi (CN); Bing WANG, Mengzi (CN); Baode LIN, Mengzi (CN); Tao ZHU, Mengzi (CN); Shizhen LI, Mengzi (CN); Yuntao LIU, Mengzi (CN); Rui ZHANG, Mengzi (CN); Yanyi XIE, Mengzi (CN); Jianlai GUO, Mengzi (CN); Yu ZHANG, Mengzi (CN); Jinkuo CAO, Mengzi (CN); Tao GUO, Mengzi (CN); Yongzhi WANG, Mengzi (CN); Bing DUAN, Mengzi (CN); Yakui DENG, Mengzi (CN); Dong LEI, Mengzi (CN); Yan QING, Mengzi (CN); Yunguang YU, Mengzi (CN); Wei YU, Mengzi (CN); Maobing LI, Mengzi (CN); Lu YANG, Mengzi (CN); Lin GAO, Mengzi (CN); Zhibin TAN, Mengzi (CN); Yanqi YAO, Mengzi (CN); Shaohua JIANG, Mengzi (CN); Wuzheng HE, Mengzi (CN); Haocheng YANG, Mengzi (CN); Yunhong XIONG, Mengzi (CN)

(21) Appl. No.: 18/619,061

(22) Filed: Mar. 27, 2024

(30) Foreign Application Priority Data
Apr. 10, 2023 (CN) 202310370223.6

(51) Int. Cl. G01R 31/62; G06F 17/11

(52) U.S. Cl. CPC G01R 31/62; G06F 17/11

(57) ABSTRACT

The present application relates to the technology field of assessment of aging state of oil paper insulation of the large power transformer and quantitative diagnostic, specifically estimating parameters of the circuit through the initial slope of the recovery voltage. It includes an improved mathematical model for solving parameters of the dielectric response equivalent circuit by using the peak of the recovery voltage, the peak time and the initial slope characteristics; transforming the identification of parameters of the equivalent circuit into a mathematical optimization problem, and then solving the mathematical optimization problem using a particle swarm algorithm. The design of the present application can significantly reduce the sampling data of the recovery voltage, and the measured data in the field and the calculated data of different capacity RVM experiments on real transformers have good consistency, which is conducive to the diagnosis of state of oil paper insulation of the transformer.

### CROSS-REFERENCE TO RELATED APPLICATIONS

The present application claims priority to Chinese Patent Application No. 202310370223.6, titled “Improved Method for Mathematical Model for Estimating Polarization Parameters of Oil Paper Insulation of Transformer”, filed Apr. 10, 2023, the entire disclosure of which is incorporated herein by reference.

### TECHNICAL FIELD

The present application relates to the technical field of assessment of the aging state of oil paper insulation and quantitative diagnosis, and specifically relates to an identification and optimization of parameters of an equivalent circuit model for oil paper insulation.

### BACKGROUND

A power transformer is one of the most important equipments in the transmission and distribution system, and the oil paper is mainly used in the insulation system, and its' life depends mainly on the aging state of the insulation system. Accurate diagnosis of moisture content of the oil paper insulation of the transformer is important to ensure the safety and reliability of operation of the transformer and to delay insulation aging.

Traditional measurement methods use Karl Fischer titration to determine trace moisture in insulating oil and estimate the moisture content in insulating cardboard based on the oil paper moisture balance curve, which requires a uniform distribution of moisture in the insulating oil and paper, and depends largely on the temperature, by which the accuracy of the test is greatly affected. As a non-destructive diagnostic method based on a dielectric response theory, compared with the traditional electrical diagnostic methods, the recovery voltage method can provide more information about the aging state of the oil paper insulation of the transformer, and the moisture content in the pressboard of the transformer can be assessed by the dominant time constant.

However, the dominant time constant in the current method is determined by the charging time and temperature as variables, and it takes a long measurement time to obtain data for the recovery voltage method because of the large charging time interval. Therefore, it is necessary to estimate the parameters of the equivalent circuit and calculate the characteristic quantity of the recovery voltage to determine the dominant time constant and shorten the measurement time. The extended Debye equivalent circuit can be used to explain the relaxation characteristics of the oil paper insulation. In order to estimate the parameters of the equivalent circuit, a suitable mathematical model needs to be selected. To address the current deficiencies, the present application proposes an improved method for estimating the parameters of the equivalent circuit of oil paper insulation of the transformer. In the improved model, the peak of the recovery voltage, the peak time and the initial slope are considered together to solve the parameters of the equivalent circuit. The advantage of the model is that two equations can be established using single-cycle measurement data of the recovery voltage, which shortens the measurement time and is suitable for large power transformers and distribution transformers.

### SUMMARY

It is an object of the present application to provide an improved method for a mathematical model for estimating polarization parameters of oil paper insulation of the transformer to solve the problem raised in the above background, the method includes:
1) applying a direct current voltage of up to 2000 V to a test object through a Tettex recovery voltmeter (RVM) during a specified charging time, obtaining characteristic parameters such as maximum polarization recovery voltage and peak time.

The measurement cycle includes a charging phase, a discharging phase, a measurement phase, and a relaxation phase.

The charging phase is two times the discharging phase.
2) replacing a uniform oil paper insulation with an equivalent circuit with an extended Debye model upon considering dielectric response characteristics of the RVM, establishing an equivalent circuit with polarization capacitance resistance and insulation capacitance resistance as unknown parameters.
3) improving the equivalent circuit of the extended Debye model by circulating the multiple measurement cycles, and establishing a set of nonlinear equations based on the maximum value of the recovery voltage, to transform a parameter identification problem into an optimization problem.
4) solving the set of nonlinear equations with a particle swarm algorithm, wherein each unknown parameter is solved by substituting at least 2n sets of characteristics of the recovery voltage into each nonlinear equation, and the particle swarm algorithm is applied for searching an optimal value, n is an integer equal to or greater than one.

The characteristics of the voltage are obtained by observing the value of the charging time for the maximum recovery voltage, the dominant time constant of the oil paper insulation can be obtained.

The technology of the present application is indisputable and the beneficial effects of the present application are as follows:
1) The improved mathematical model of the present application can reduce the sampling data of the recovery voltage.
2) The method proposed in the present application is applicable not only to large power transformers but also to distribution transformers.
3) The recovery voltage curve calculated by the present application has good consistency with the measured recovery voltage curve, which is conducive to the diagnosis of the state of oil paper insulation of the transformer.

The present application proposes an improved mathematical model to solve the parameters of dielectric response equivalent circuit by using the peak of the recovery voltage, the peak time and initial slope characteristics. The advantage of the model is that the single-cycle measurement data of the recovery voltage is used to establish two equations, which shortens the measurement time. The solution of the equations for the parameters of the equivalent circuit is transformed into an optimization problem, which can be used to identify the parameter values efficiently.

### BRIEF DESCRIPTION OF THE DRAWINGS

FIG. 1 is a flowchart of an exemplary algorithm for determining an insulation polarization parameter according to the present application.

FIG. 2 is a diagram of an exemplary RVM dielectric response equivalent circuit according to the present application.

### DETAILED DESCRIPTION OF THE EMBODIMENTS

The technical solutions in the embodiments of the present application will be described clearly and completely in the following in conjunction with the accompanying drawings in the embodiments of the present application, and it is obvious that the described embodiments are only a part of the embodiments of the present application and not all of the embodiments. Based on the embodiments of the present application, all other embodiments obtained by those skilled in the art without making creative labour fall within the scope of the present application.

### Embodiment I

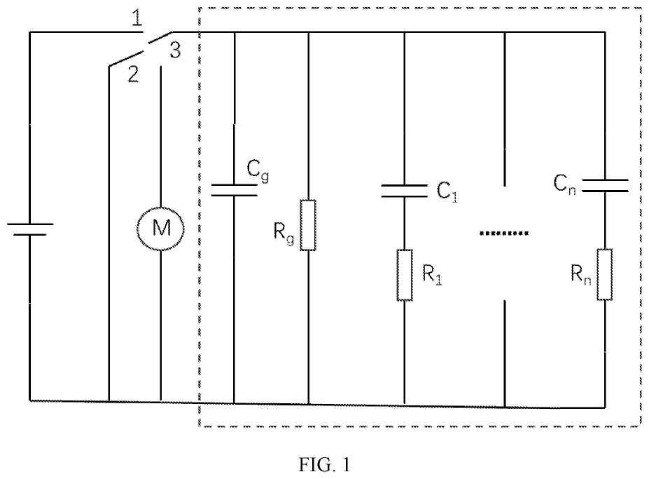

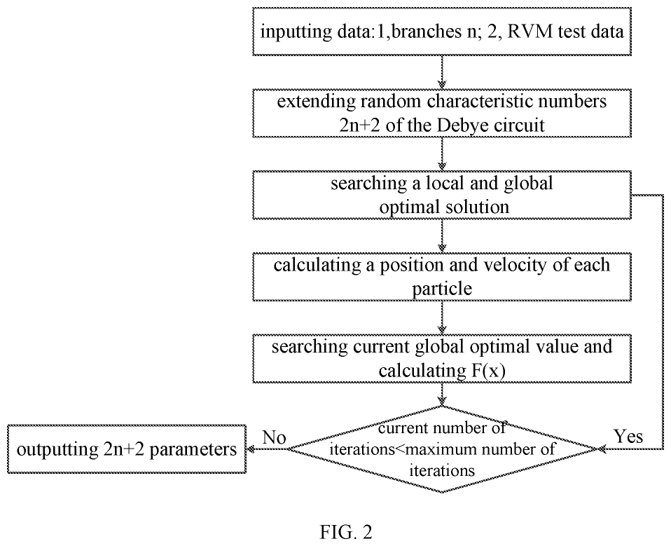

Referring to FIGS. 1 to 2, the present application provides an improved method for a mathematical model for estimating polarization parameters of oil paper insulation of the transformer, the method includes:
1) applying a direct current voltage of up to 2000 V to a test object through a Tettex recovery voltmeter (RVM) during a specified charging time, obtaining characteristic parameters such as maximum polarization recovery voltage and peak time.

The measurement cycle includes a charging phase, a discharging phase, a measurement phase, and a relaxation phase.

The charging phase is two times the discharging phase.
2) replacing a uniform oil paper insulation with an equivalent circuit with an extended Debye model upon considering dielectric response characteristics of the RVM, establishing an equivalent circuit with polarization capacitance resistance and insulation capacitance resistance as unknown parameters.
3) improving the equivalent circuit of the extended Debye model by circulating the multiple measurement cycles, and establishing a set of nonlinear equations based on the maximum value of the recovery voltage, to transform a parameter identification problem into an optimization problem.
4) solving the set of nonlinear equations by using a particle swarm algorithm, wherein each unknown parameter is solved by substituting at least 2n sets of characteristics of the recovery voltage into each nonlinear equation, and the particle swarm algorithm is applied for searching an optimal value, n is an integer equal to or greater than one.

The characteristics of the voltage are obtained by observing the value of the charging time for the maximum recovery voltage, the dominant time constant of the oil paper insulation can be obtained.

### Embodiment II

A particle swarm optimization algorithm for extending parameters of the Debye circuit based on characteristics of the RVM is shown in FIG. 2, which includes:
Step 1, testing two new three-phase power transformers T1 and T2 of 240 MVA and 220 kv in the field by using a charging voltage of 2000 V and a charge/discharge time ratio of 2 to obtain RVM data;
Step 2, establishing a circuit based on n branches of the extended Debye circuit, and setting 2n+2 circuit characteristic parameters for an insulation resistance capacitance and a polarization capacitance resistance.
Step 3: solving equations by using a particle swarm algorithm when the recovery voltage is maximum, to obtain an optimal solution of the extended Debye circuit.

1. An improved method for a mathematical model for estimating a polarization parameter of oil paper insulation of a transformer, comprising:
based on a dielectric response theory, applying a direct current voltage of up to 2000 V to a test object through a Tettex recovery voltmeter (RVM) during a specified charging time, wherein the RVM requires multiple measurement cycles, each of which is divided into a charging phase, a discharging phase, a measurement phase, and a relaxation phase;
multiple relaxation times existing in an oil paper composite medium, and replacing a uniform oil paper insulation with an equivalent circuit with an extended Debye model upon considering dielectric response characteristics of the RVM;
improving the equivalent circuit of the extended Debye model by circulating the multiple measurement cycles, and establishing two nonlinear equations in the extended Debye model with measurement data, to identify all unknown parameters in the equivalent circuit of the extended Debye model; and
solving the two nonlinear equations by using a particle swarm algorithm, wherein each unknown parameter is solved by substituting at least 2n sets of recovered voltage characteristics into each nonlinear equation, and the particle swarm algorithm is applied for searching an optimal value, n is an integer equal to or greater than one.

2. The improved method for the mathematical model for estimating the polarization parameter of oil paper insulation of the transformer according to claim 1, wherein the specified charging time of the RVM is twice the discharging time.

3. The improved method for the mathematical model for estimating the polarization parameter of oil paper insulation of the transformer according to claim 1, wherein solutions of two nonlinear equations are transformed into an optimization problem through circuit parameters obtained by the RVM.
